(19) United States
(12) Patent Application Publication
(10) Pub. No.: US 2017/0076393 A1
(43) Pub. Date: Mar. 16, 2017

(54) Digital Inventory System

(71) Applicant: Michael Jacob Cohen, Tucson, AZ (US)

(72) Inventor: Michael Jacob Cohen, Tucson, AZ (US)

(21) Appl. No.: 14/851,416

(22) Filed: Sep. 11, 2015

(51) Int. Cl. G06Q 40/08; G06Q 10/08

(52) U.S. Cl. CPC G06Q 40/08; G06Q 10/0875

(57) ABSTRACT

An inventory technology that works with computers, smartphones and devices that assists in creating a personal property inventory for insurance purposes wills, probate, taxes and or other needs. An inventory may be prepared before an insurance loss occurs by use of photos, videos, user input and vender supplied receipts. A user may link gift store registries with the technology for updating and or ordering replacement personal property after a loss. For users without a list after disaster strikes, fire, burglary etc., the technology has an “after tool” to help users re-construct personal property inventory. The Memory Assist module provides suggestions based on typical homeowner and knowledge base data and illustrated on a room by room basis. The professional model combines both the before and after tools in one, along with depreciation tables and allowing for exchanging communications and documentation between the user and the claims processor.

### CROSS-REFERENCE TO RELATED APPLICATIONS

Not Applicable

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever. Such trademark(s) may include, Digi Inventory™, Digi Disaster Inventory™, DigiInventory™, SecureMyValuables™, SecureMyValuablesNow™, Digi-In™ and Put in My Vault™.

### BACKGROUND OF THE INVENTION

(1) Field of the Invention

The invention generally relates to inventory listing systems. More particularly, the invention relates to means and methods of creating inventory lists using prompts and databases, with such inventory lists optionally modified and augmented for use in insurance claims.

(2) Description of the Related Art

The known related art fails to anticipate or disclose the principles of the present invention.

In the related art, Excel spread sheets and other computer implemented systems may be used to assist in creating an inventory listing. Such methods, including the prior art method of writing out assets on a sheet of paper, suffer the short fall of requiring the manual input of all assets, including the manual input of all asset attributes. Thus, an inventory listing is a formidable task, subject to procrastination, as a homeowner or other policy holder may not know all of the relevant attributes of each household item. Thus, there are serious shortfalls in the related art.

### BRIEF SUMMARY OF THE INVENTION

Disclosed embodiments assist consumers in producing lists of personal possessions on a 1) proactive basis, before a disaster and on a 2) post disaster basis, after a theft or fire. While there is cross over in the use of external databases for either implementation, one subsystem may be considered a “before tool” and a second subsystem may be considered an “after tool.” The “before tool” or pre-loss system may be known as or referred to as Digi Inventory™ or DI while the post lost tool or “after tool” may be known as Digi Disaster Inventory™ or DDI.

The present invention overcomes shortfalls in the related art by presenting an unobvious and unique combination and configuration of methods and components to provide a machine implemented system that assists homeowners or apartment dwellers to quickly and carefully record and catalog all of their personal possessions. Disclosed embodiments may include a memory assist feature wherein a user interface is in communication with a server system and the server system may be in communication with a plurality of databases. The plurality of databases may contain catalogues of consumer items, with the optional attributes of each item readily available. The server system may also be in communication with online resources, such as wedding registries, for pricing verification [or price checks] and to further expand the content and quality of drop down item menus presented. For example, as items are purchased via a wedding or gift registry, such items are added to the consumer's database system.

Disclosed embodiments overcome shortfalls in the related art by presenting a user interface comprising drop down menus and submenus to provide an efficient point and click experience in creating an inventory of personal items. By the artful use of prepopulated databases of personal items and connectivity with outside registries, almost any personal item is available for selection and inclusion to a homeowner's list of assets. The submenus may list product models and optional product features to provide an extremely accurate product listing and pricing.

Disclosed embodiments overcome shortfalls in the art by the display of likely companion items based upon the input of items owned by a consumer. For example, a consumer may input a television system and compatible ancillary items such as a DVD player may be displayed for selection.

Disclosed embodiments overcome shortfalls in the art by cross referencing life style databases to ascertain the probability of consumer fraud in claiming ownership to outlier suspect products.

Products selected for inclusion may also carry unseen product attributes such as fair market value. Products selected for inclusion may also contain or trigger prompts of related items or items often purchased with the subject item. Thus, the homeowner obtains a thorough and fair listing of property owned. Such a thorough listing may result in an increase of purchased insurance coverage and a more satisfying consumer experience. For the insurer, such a list results in faster and more accurate claim settlement.

Embodiments of the invention may also include means and methods of movie and picture upload to further confirm the possession and condition of listed items as well as items in their former condition. Receipts may also be uploaded.

A disclosed embodiment may include a Deluxe Version having memory assist and/or a standard version that is devoid of the disclosed database and connectivity systems. In product listing creation and in the valuation and organization of a product list, the use of categories with numerous subcategories may be used.

Disclosed embodiments may include an insured registration portal and a parallel insurance claims adjustor login. The insurance claims adjustor login may reveal or view patterns of inconstant inventory listings, such as items not typically found together or items inconsistent with the known attributes of the insured.

Disclosed embodiments include “Put in my Vault” technology enabling consumers to directly transmit digital receipts to a personal electronic system. Upon completing a purchase with a participating vendor, the receipt and other transaction information is transmitted to a secure storage system. The secure storage system may be in communication with other disclosed components to facilitate quick retrial of purchased item information in the event of loss.

Disclosed embodiments include the implementation of object recognition technology wherein product information derived by use of digital photos and movies of consumer goods. Product bar codes may also be scanned to add inventory to a consumer's database.

Disclosed embodiments include the implementation of three dimensional room views to facilitate a consumer's entry of personal property and subsequent generation of property lists.

Disclosed embodiments provide new efficiencies in the art and provide system operators with monetization opportunities as selected vendors may present goods and services to consumers after a loss. Selected vendors may present items comporting to the lost items and may offer discounts and/or commission payments to system operators. Selected vendors may provide valuable input and services such as identifying what may be salvaged [saved] from non-salvageable [totaled] and offer to make repairs and restoration where necessary to salvageable items.

In a before tool subsystem or embodiment a consumer may assemble a comprehensive list of items owned. After a theft or fire or other partial loss, a consumer may select times from their completed or master inventory list and select and organize property into relevant categories to reflect the consequences of the loss. This allows the insured-end-user to identify and separate damaged from undamaged items in order to mitigate damages and comply with preservation of property requirements.

Disclosed embodiments include various means and methods of monetization of the disclosed systems and subsystems. Both the “before tools” and “after tools” may be offered to insurers on a fee basis. Such an arrangement will allow insurers to provide the disclosed systems to their policyholders for no cost or nominal cost, while providing an incentive [discount or other] to their policyholders to encourage policyholders to complete an inventory of their personal property. Insurers would enjoy many advantages, including better control of the claims process, fewer expenses in handing claims, and most importantly, the ability to sell more insurance. Insurers will benefit by maintaining and increasing customer retention as policy holders will know they are receiving fair compensation for their claim.

Disclosed embodiments allow insurance companies, via their insurance agents, supervised by a tiered system within the insurance company, to fully understand and comprehend the needs of their policyholders regarding personal property. The disclosed systems technology can reveal coverage weakness such as being underinsured and/or the need to protect specific insurance for valuables and collectibles. Certain homeowners and renters policies either exclude or dramatically limit coverage for highly valuable items like fine art, jewelry, furs, firearms, and the family silver especially from claims related to burglary or theft. The same can be said of home business equipment insurance and identity theft insurance, for which an insurer will gladly provide additional protection.

Disclosed embodiments allow for agents to settle small and nuisance claims within their authority since disclosed database systems allow exchanges of communication between an insurance agent and the insured, and also allows for the sending of attachments such as claim forms, correspondence and other items.

For insurance companies the “after tool” has several unique features. One allows for the adjuster to assist an insured claimant to log on to the disclosed server system using credentials provided by the adjuster, so that the insured-claimant can commence compiling their inventory. The memory assist feature provides guidance to insured claimants while providing supervision tools to the insurer. The technology has a feature upon initiating a claim whereupon the system searches for possible open or duplicative claims [fraud prevention] the claimant may have or have had, [even with other insurance companies] order to avoid overpayment, duplicate payments which is extremely useful during catastrophic wide spread loss such as from a Storm, Hurricane, Flood, or Earthquake losses.

Disclosed embodiments provide adjustors additional tools, such as depreciation tables and the ability to “see” all the activity performed by the insured. In addition, communication between adjuster and the insured claimant is two-way, with claims forms, files, correspondences, attachments and various messages exchanged back and forth. This enables considerable savings or reassignment of valuable resources.

Disclosed embodiments include means and methods of creating a list or database of personal property items for insurance claims, wills, probate, taxes, commercial claims and other needs. An inventory, database or list of personal property may be prepared before an insurance loss by use of photos, videos, user input and vender supplied receipts. After a loss, a user may link vendor registries with the disclosed system for updating and/or ordering replacement items after a loss.

A disclosed Memory Assist module may provide suggestions based upon typical homeowner and knowledge databases and system generated illustrations to assist in asset listing. A disclosed professional model combines both the before and after tools in one system and may include depreciation tables and system servers for exchanging communications and documentation between the user and the claims processor.

These and other objects and advantages will be made apparent when considering the following detailed specification when taken in conjunction with the drawings.

### BRIEF DESCRIPTION OF THE DRAWINGS

FIG. 1 depicts a schematic view of a contemplated process

FIG. 2 depicts a schematic view of a contemplated hardware architecture

FIG. 3 depicts a schematic view of a contemplated hardware architecture

### REFERENCE NUMERALS IN THE DRAWINGS

100 insured registration login or logon
120 insurance adjustor login or logon
200 initial interface for an insured
220 interface to create a location for items held
240 interface to activate a location for items held
260 interface and means to accept a claim, an insurance company may set up a disclosed system and enable system features for both the insured and claims representative and third party vendors
300 a decision tree for the selection of either a deluxe version or a standard version
310 an interface and system enabling the uploading of movies, images and other artifacts related to the possession of personal property
320 a deluxe version interface
340 a standard version interface
400 an interface and system to add or select product categories
500 an interface and system to add products via a memory assist engine, module or system
520 a second option where the insured may file a claim after purchasing and working with the DDI product as differentiated from the 260 above where the DDI product was contributed to the insured by the insurance company
600 an interface and system to add products via user input only
620 a claim is filed where the insured has already purchased the DI or the DDI product and has recorded its inventory
650 When a claim is filed, either at 260 or 620 the insurance company engages a 3rd party vendor to review losses and potential repairs. The 3rd party vendor will have access to the technology and become party to the communication module between the insured and the claims processor.
700 a system and interface that submits and prints an inventory of items
800 a system and interface enabling an insurance adjustor to view an insured's inventory and make adjustments for fair market value or adjustments under other parameters
810 the ALE tool “Additional Living Expenses” is used to assess, calculate and document all additional living expenses incurred by the insured due to its losses.
820 claim package wherein the claim processor compiles and creates a complete claim submission document including a cover letter, claim details with summary statement, all pertinent correspondence, documents and final segregated (mitigated) inventory losses adjusted for depreciation or other.
840 claim package submission to insurance company
860 gift registries where user customers can retrieve market pricing while building their inventories prior to a claim as well as where settled claim customers can go to purchase and replace lost items.
900 “before tool” subsystem
1000 “after tool” subsystem
1100 database system
1110 database of wedding or gift registries
1120 database of vendor supplied receipts
1130 database of companion products
1140 database of vendors
1150 Put in My Vault database
1155 database of master inventory lists
1160 database of virtual 3D product rooms
1165 database of product to lifestyle associations
1200 system server
1300 consumer or insured
1400 insurer
1500 product replacement vendors
1600 memory assist module
1700 object recognition system

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

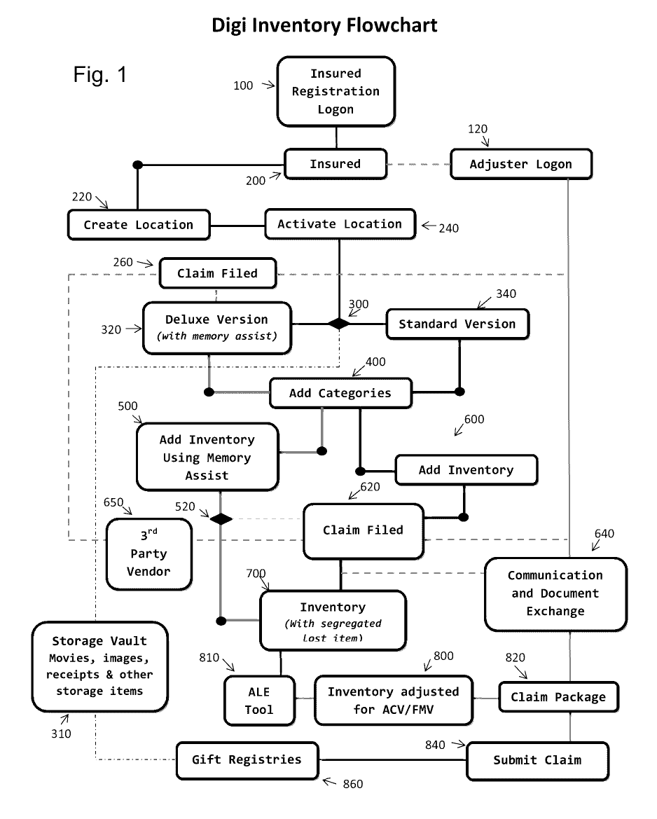

FIG. 1 a disclosed architecture that may comprise an insured registration 100 login or logon allowing an insured or consumer to access an initial interface 200. The system may also comprise an adjuster login 120 or logon giving the adjustor a back end view of listed inventory, fair market values and discrepancy flags. Discrepancy flags may be triggered when a consumer claims to own items that do not fit the profile of their other items or that stand out as unusual in light of the totality of the consumer's circumstances. The adjustor, or other insurance company representative, may have access to a fair market value engine or database system that assists deriving the fair market value of listed items.

A consumer may engage an interface to create a location 220 that houses or stores the listed times. A location may be activated 240 and thus trigger various parameters to assist in completing the listing and in triggering discrepancy flags. After a location is activated, the consumer may be presented with a decision tree 300 providing a choice of either a deluxe version, having a memory assist system or a standard version 340, akin to pen and paper. The owners or operators of the disclosed invention may obtain premium payments for use of the deluxe version.

In either the deluxe version or standard version, a consumer may add categories 400 to comport with the items owned by the consumer. In the deluxe version, the consumer may add inventory using a memory assist 500 system or engine. A memory assist system may comprise a plurality of inventory databases that have been prepopulated with consumer products and their respective attributes. Such product attributes may comprise typical purchase prices, deprecation tables and typical items purchased in tandem. A memory assist system may have real time access to wedding or gift registries in general or wedding and gift registries used by the particular consumer. A memory assist system may comprise a plurality of drop down menus and submenus to assist in a consumer's addition of products owned.

In a standard version 340 embodiment, a consumer may type in their list of personal items.

In either version, a consumer may print and/or send 700 their inventory listing. The listing may be sent to an insurance adjustor or other party for storage and/or evaluation.

Furthermore, in step 260 a claim may be filed and an insurer may set up a DDI product and login and share system attributes with an insured.

In step 520, a second option is presented wherein the insured may file a claim after purchasing and working with the DDI product as differentiated from the 260 above where the DDI product was contributed to the insured by the insurance company.

In step 620, a claim may be filed wherein an insured has already purchased the DI or the DDI product and has recorded its inventory.

640 is a communication and documentation exchange module for direct correspondence, data and document exchange between the insurance claim processor and the insured.

650 may be a third party vendor and comprise a step wherein, either at 260 or 620 the insurance company engages a third party vendor to review losses and potential repairs and assist in determining what is salvageable from non-salvageable as well as what can be repaired, restored or must be replaced. The third party vendor will have access to the technology and become party to the communication module between the insured and the claims processor.

810 is a step or process wherein an ALE tool “Additional Living Expenses” is used to assess, calculate and document all additional living expenses incurred by the insured due to its losses.

820 is a step or process wherein a claim processor compiles and creates a complete claim submission document including a cover letter, claim details with summary statement, non-waivers, sworn statement in proof of loss, all pertinent correspondence, documents and final segregated (mitigated) inventory losses adjusted for depreciation or other.

840 is a step or process wherein a claim package or claim elements are submitted or transmitted to an insurance company.

860 is a step or process wherein system users or customers may access gift registries to retrieve market pricing while building their inventories prior to a claim as well as where settled claim customers can go to purchase and replace lost items.

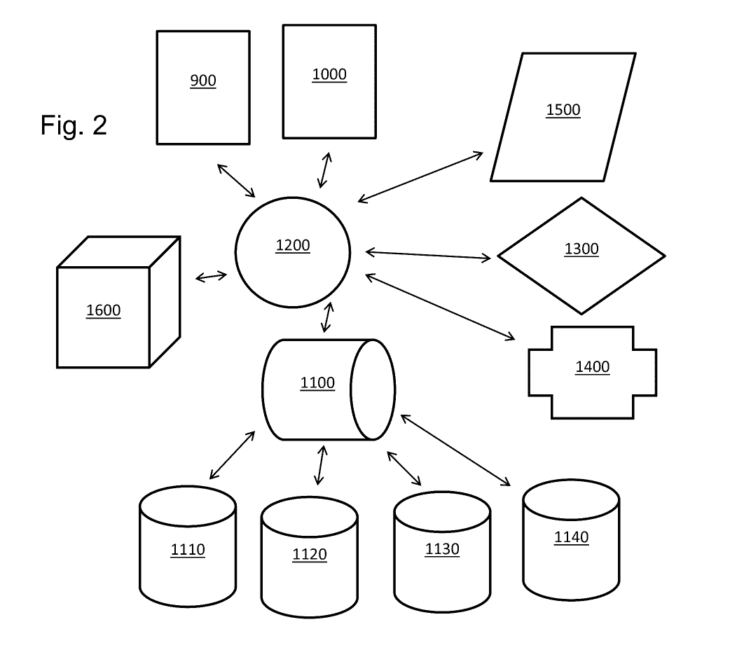

FIG. 2 depicts a disclosed hardware architecture wherein a system server 1200 is in communication with a “before tool” subsystem 900 and an “after tool” subsystem 1000. The server 1200 is in further communication with a database system 1100 which may comprise a plurality of integrated or separate databases such as a database of wedding or gift registries 1110, a database of vender supplied receipts 1120, a database of companion products 1130 and a database of vendors 1140.

The server 1200 is also in communication with consumers or insureds 1300, insurers 1400 and product replacement vendors 1500.

The “after tool” subsystem 1000 may access the database system 1100 and related databases to create various drop down lists to assist in creating a master post incident inventory list. The databases may help to create the memory assist module 1600 that produces companion items that are likely to have been purchased with a user selected item. The “after tool” subsystem 1000 may also access gift registries 1110 and similar databases after a loss to check for pre-loss purchases.

The “before tool” subsystem 900 may continuously update a consumer's master inventory list as purchases are reported by vendors, gift registries and the consumer. The “before tool” subsystem is the preferred method of creating a master inventory list as receipts are easily stored and the likelihood of consumer fraud is diminished.

In the event of a loss, a partnered product replacement vendor 1500 may offer replacement products to the insured. Arrangements with system operators may facilitate direct payment from insurers to product replacement vendors 1500 as an accommodation to the insured.

Insureds 1400 may be given restrained access to the system server 1200 to update master inventory lists and to report losses and to communicate directly with insurers 1400.

The server system 1200 may comprise a general or specialized processor, non-volatile memory, machine readable media containing machine readable instructions and access to a network, such as the Internet. The server system 1200 may be controlled, maintained and monetized by operators of the system.

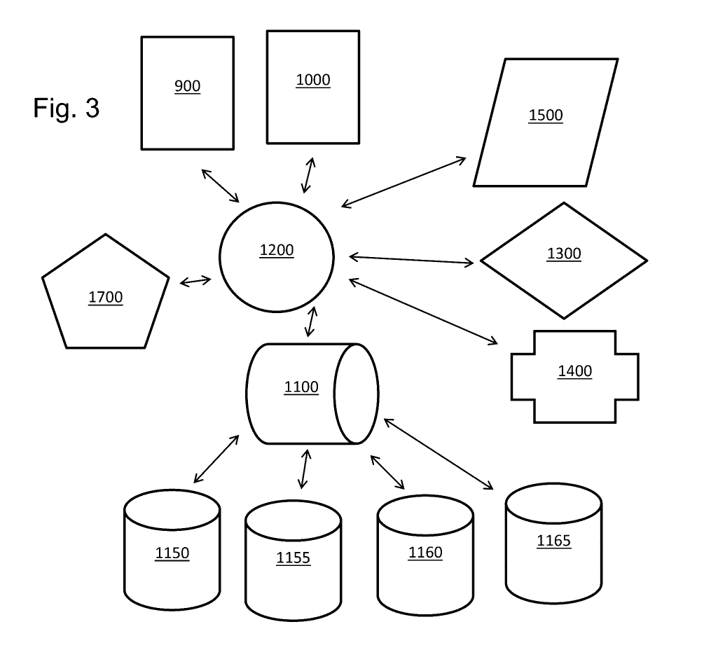

FIG. 3 depicts the system of FIG. 2 but includes a Put in My Vault™ database 1150, a database of master inventory lists 1155, a database of virtual 3D product rooms 1160 and a database of product to lifestyle associations 1165. The Put in My Vault™ database may accept receipts from vendors and from insureds. An insurer may monitor the contents of a master product list or vault contents to look for insurance shortfalls and to suggest insurance upgrades.

FIG. 3 further depicts an object recognition engine 1700 or system to derive product attributes from consumer supplied photos or videos. The object recognition system maps an insured's product to a system database or list of products to populate the insured's master property list.

A database of virtual 3D product rooms 1160 provides a visualization of rooms with contents selected by an insured. Seeing a realistic representation of an insured's room assists the insured in recalling products owned before a loss. The database of life style associations 1165 triggers warnings when a property claimed by an insured does not statistically mesh with other property owned by the insured. The database of life style associations may be continuously populated with inventory groupings gleaned from consumers in order to stay current on typical groupings or associations of products.

Disclosed embodiments may include the following items.

Item 1. A computer implemented system of providing a “before tool” subsystem and an “after tool” subsystem used to create a master inventory list either before a property loss or after a property loss, the system comprising:

a) a server system 1200, the server system comprising a processor, non-volatile memory, machine readable media containing machine readable instructions, the sever system in communication with;

b) a database system 1110, the database system comprising a plurality of databases, the plurality of databases comprising a database of gift registries 1110, a database of vendor supplied receipts 1120 and a database of master inventory lists 1155;

c) the system server in further communication with one or more insurers 1400, one or more insureds 1300 and one or more product replacement vendors 1500;

d) the system server in communication with a display interface system, FIG. 1, the display interface system an insured registration login interface 100, an insurance representative login interface 120, a create location interface 220, an activate location interface 240, a memory assist interface 320, an add categories of products interface 400 and an add inventory using memory assist interface 500.

Item 2. The system of 1 further including a server system in communication with a user interface 800 enabling an insurance representative to view an insured's inventory and make adjustments for fair market value or adjustments under other parameters.

Item 3. The system of 1 further comprising a database of product replacement vendors 1500 in communication with the system server and in communication with a plurality of vendors.

Item 4. The system of 1 further comprising a memory assist module 1600.

Item 5. The system of 1 further comprising an object recognition system 1700 configured to derive product attributes from input of digital photos and digital video.

Item 6. The system of 1 further comprising a database of product lifestyle associations 1165, with the system server comparing an insured's master product list with product lists of the lifestyle associations database to derive statistical anomalies in an insured's claimed master property list.

Item 7. The system of 1 further comprising database of virtual 3D product rooms 1160 in communication with the system server the database of virtual 3D product rooms presenting a display of products within a representation of an insured's room.

Item 8. The system of 1 wherein the database of gift registries is in further communication with a plurality of vendors providing gift lists of insureds.

Item 9. The system of 1 wherein the database of master inventory lists comprises master lists of inventory for insureds and the master lists of inventory are populated by either the “before tool” subsystem or the “after tool” subsystem.

What is claimed is:

1. A computer implemented system of providing a “before tool” subsystem and an “after tool” subsystem used to create a master inventory list either before a property loss or after a property loss, the system comprising:
a) a server system, the server system comprising a processor, non-volatile memory, machine readable media containing machine readable instructions, the server system in communication with;
b) a database system, the database system comprising a plurality of databases, the plurality of databases comprising a database of gift registries, a database of vendor supplied receipts and a database of master inventory lists;
c) the system server in further communication with one or more insurers, one or more insureds and one or more product replacement vendors;
d) the system server in communication with a display interface system, the display interface system an insured registration login interface, an insurance representative login interface, a create location interface, an activate location interface, a memory assist interface, an add categories of products interface and an add inventory using memory assist interface.

2. The system of claim 1 further including server system in communication with a user interface enabling an insurance representative to view an insured's inventory and make adjustments for fair market value or adjustments under other parameters.

3. The system of claim 1 further comprising a database of product replacement vendors in communication with the system server and in communication with a plurality of vendors.

4. The system of claim 1 further comprising a memory assist module.

5. The system of claim 1 further comprising an object recognition system configured to derive product attributes from input of digital photos and digital video.

6. The system of claim 1 further comprising a database of product lifestyle associations, with the system server comparing an insured's master product list with product lists of the lifestyle associations database to derive statistical anomalies in an insured's claimed master property list.

7. The system of claim 1 further comprising database of virtual 3D product rooms in communication with the system server the database of virtual 3D product rooms presenting a display of products within a representation of an insured's room.

8. The system of claim 1 wherein the database of gift registries is in further communication with a plurality of vendors providing gift lists of insureds.

9. The system of claim 1 wherein the database of master inventory lists comprises master lists of inventory for insureds and the master lists of inventory are populated by either the “before tool” subsystem or the “after tool” subsystem.

10. The system of claim 1 further comprising a display interface, the display interface configured to send and receive messaging with multiple forms of attachments, the attachments comprising recorded video documentation and audio statements, the attachments used for claim discovery, verification and retention, the attachments transmitted between one or more insurers, the insurers respective representatives, one or more insureds, one or more vendors of claim services.

11. The system of claim 4 wherein the memory assist module comprises the input of proof of purchase sales receipts, parsed on a room by room basis and parsed for more than one property, the proof of purchase sales receipts inputted by members of a group, the group comprising insureds, vendors and merchants, the proof of purchase sales receipts inputted by use of point of sale systems or email or registry systems.
